(19) United States
(12) Patent Application Publication
(10) Pub. No.: US 2014/0379551 A1
(43) Pub. Date: Dec. 25, 2014

(54) INSTANTLY BACK-TESTING TRADING STRATEGIES IN AN OPTIONS PORTFOLIO

(71) Applicant: Morris Donald Scott PUMA, San Jose, CA (US)

(72) Inventor: Morris Donald Scott PUMA, San Jose, CA (US)

(21) Appl. No.: 14/312,662

(22) Filed: Jun. 23, 2014

Related U.S. Application Data
(60) Provisional application No. 61/837,634, filed on Jun. 21, 2013.

(51) Int. Cl. G06Q 40/04

(52) U.S. Cl. CPC G06Q 40/04
USPC 705/37

(57) ABSTRACT

A technique for options trading, and more specifically, to analyzing an options trade instantaneously that may be live or potentially initiated.

### CROSS REFERENCE TO RELATED APPLICATIONS

This application claims the benefit of U.S. Provisional Application No. 61/837,634, filed on Jun. 21, 2013, the content of which is incorporated herein by reference in its entirety.

### FIELD OF THE INVENTION

The invention relates generally to computer software for options trading, and more specifically, to analyzing an options trade instantaneously that may be live or potentially initiated.

### BACKGROUND

Options trading involves a contract which gives the owner the right to buy or sell an underlying asset or instrument at a specified strike price on or before a specified date. For example, a long call option gives the buyer the right, but not the obligation, to buy the underlying asset at a certain price, the strike price, during the life of the contract. To the contrary, a long put contract gives the owner the right, but not the obligation, to sell the underlying asset at a specified price, the strike price, during the life of the contract. There are many ways options to use options. Options are used for hedging as well as for speculative income. Sometimes an option trader will sell options with hopes they will expire worthless while other traders might attempt to make a profit through a directional move with either price or volatility. There are infinite ways to construct option spreads. Options are derivative financial instruments because the value is derived from underlying assets, rather than in and of itself. The transactions can be guaranteed by clearinghouses such as the Chicago Board Options Exchange.

Stress tests attempt to determine the profit or loss potential of an options trade using historical data or theoretical option pricing models. Currently, there is no way for traders to quickly and efficiently back test or stress test options positions using historical data or option pricing models. Instead, each trade has to be manually back tested or stress-tested using options analytical software. The standard steps in the industry to perform a back test include: identify calendar dates on a price chart, go to the specific date using the software, construct the desired trade, manually advance the calendar to reveal profit and loss, and write down results and perform another back test. Each small back test can take between 5 and 30 minutes depending on the trade complexity. For example, a user can spend 30 minutes to an hour back testing an entire asset portfolio with 20 or more strikes over just one, single scenario.

Thus, an options trader must rely on pricing models that use theoretical data to study trades (e.g., Black Scholes), and estimate risk and profit potential. However, even this process is tedious. Current software requires a user to perform only one stress test at a time using these models. This is very time consuming. Furthermore, the way software is designed doesn't allow the user to perform the stress-test accurately. Typically, a user will estimate the amount volatility will change over various months as well as time. However, very important information is left out. Volatility changes differently across different months. A more accurate approach is needed to allow more accurate stress-testing as well as a faster way to do this. In addition to it being difficult to use current pricing models accurately, these traditional pricing models omit very important information such as bid-ask spread issues, liquidity and human emotion. Analyzing risk based on the current models are problematic because the trader cannot see the true risk involved in the trades and the entire portfolio. Traders often times over extend their margin and blow out their accounts because they do not have an efficient way to calculate their real risk exposure. Traders also have a difficult time making consistent returns because again, they have to rely on inaccurate theoretical pricing models that are not close enough to reality. With option trading, a few percent off on one's risk analysis can make all the difference.

What is needed is a robust technique to automatically apply a set of historical back tests using real data and stress tests using option pricing models to an asset portfolio in view of these problems.

### BRIEF DESCRIPTION OF THE DRAWINGS

In the following drawings, like reference numbers are used to refer to like elements. Although the following figures depict various examples of the invention, the invention is not limited to the examples depicted in the figures.

FIG. 1A is a high-level block diagram illustrating a system to instantly back-test and stress-test trading strategies of an options portfolio, according to one embodiment.

FIG. 1B is a more detailed block diagram illustrating a historical price database of the system of FIG. 1A, according to one embodiment.

FIG. 1C is a more detailed block diagram illustrating a back test server of the system of FIG. 1A, according to one embodiment.

FIG. 1 D is a more detailed block diagram illustrating a user device of the system of FIG. 1A, according to one embodiment.

FIG. 2A is a screen shot of configuration options for back-testing an options portfolio, according to one embodiment.

FIG. 2B is a screen shot of historical data model options for back-testing an options portfolio, according to one embodiment.

FIG. 2C is a screen shot of adjustment process configuration options for back-testing an options portfolio, according to one embodiment.

FIG. 2D is a screen shot of trade configuration options for back-testing an options portfolio, according to one embodiment.

FIG. 2E is a screen shot of evaluation output for back-testing an options portfolio, according to one embodiment.

FIG. 2F Side by Side is a screen shot of the Side by Side feature which allows the user to view the back test along-side the trade being back tested according to one embodiment.

FIG. 3 is a high-level flow diagram illustrating a method for instantly back-testing trading strategies in an options portfolio, according to one embodiment.

FIG. 4 is a more detailed flow diagram illustrating a step of configuring stress tests for an options portfolio in the method of FIG. 3, according to one embodiment.

FIG. 5 is a block diagram illustrating an exemplary computing device, according to one embodiment.

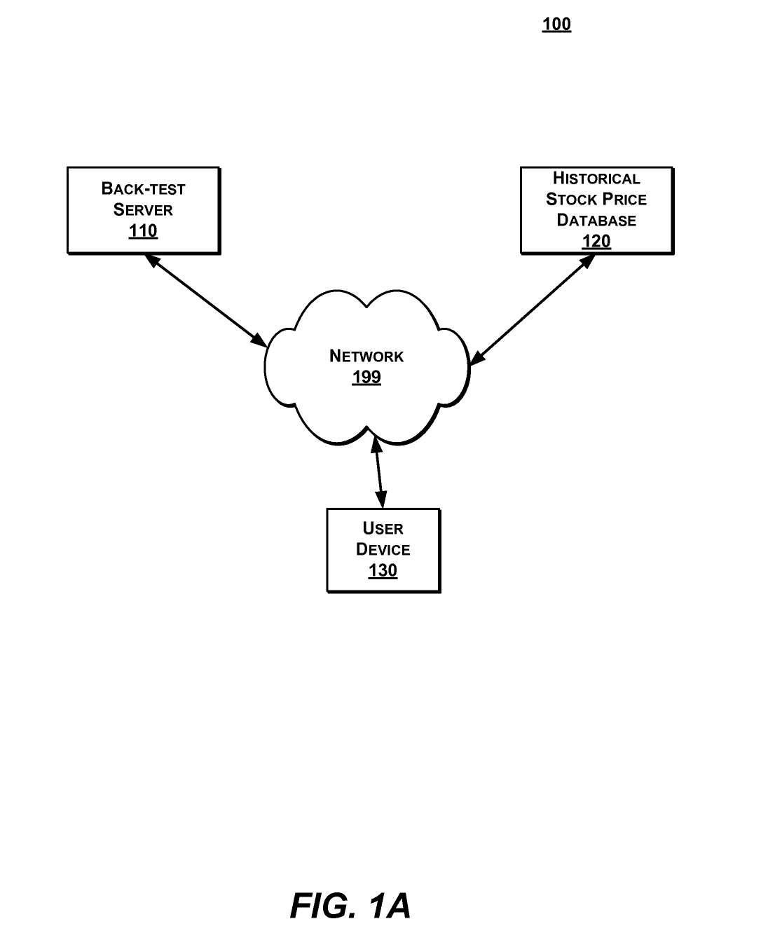

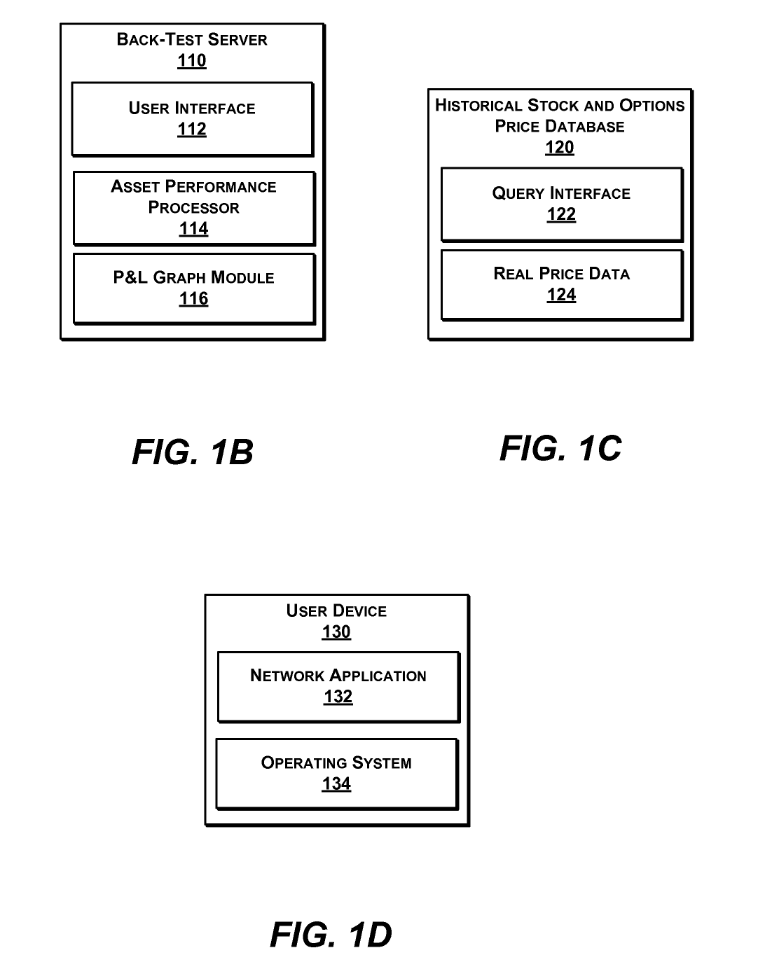

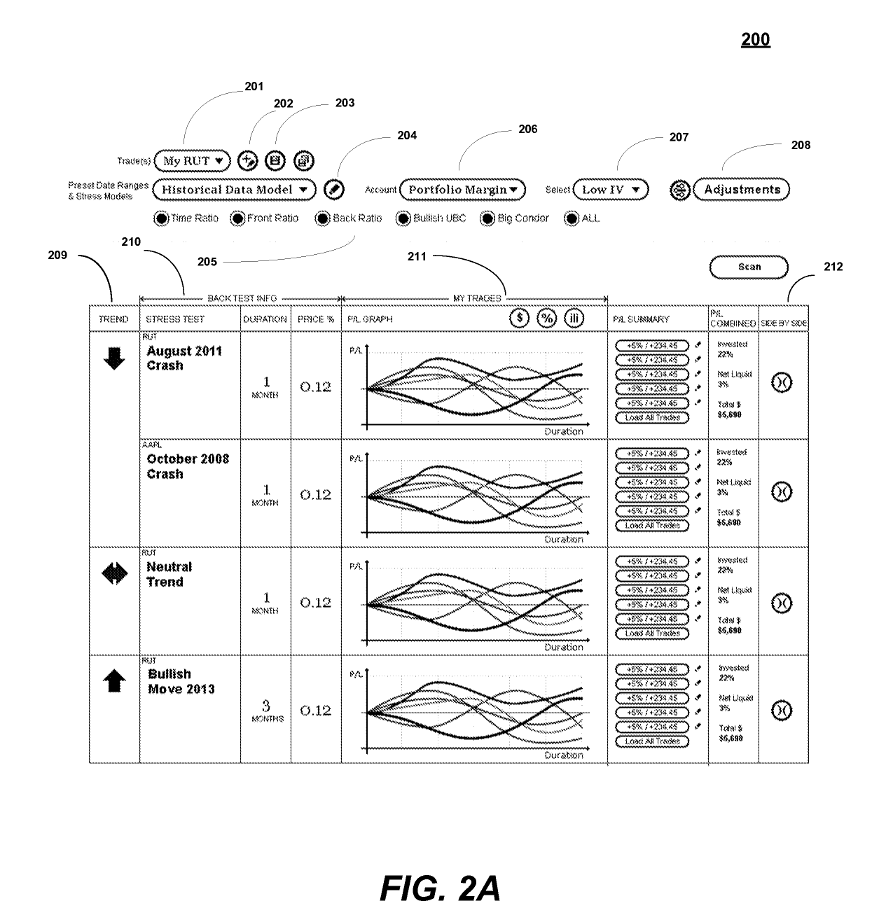

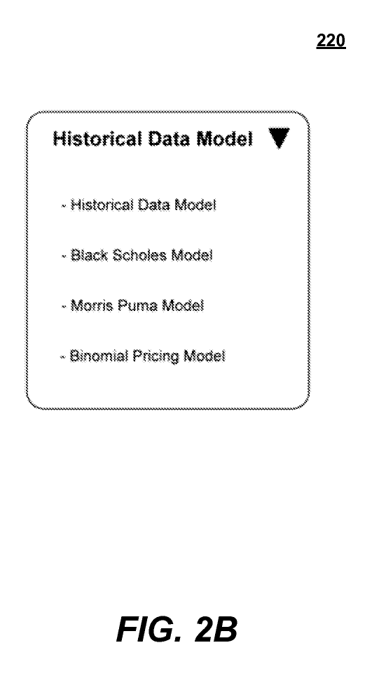

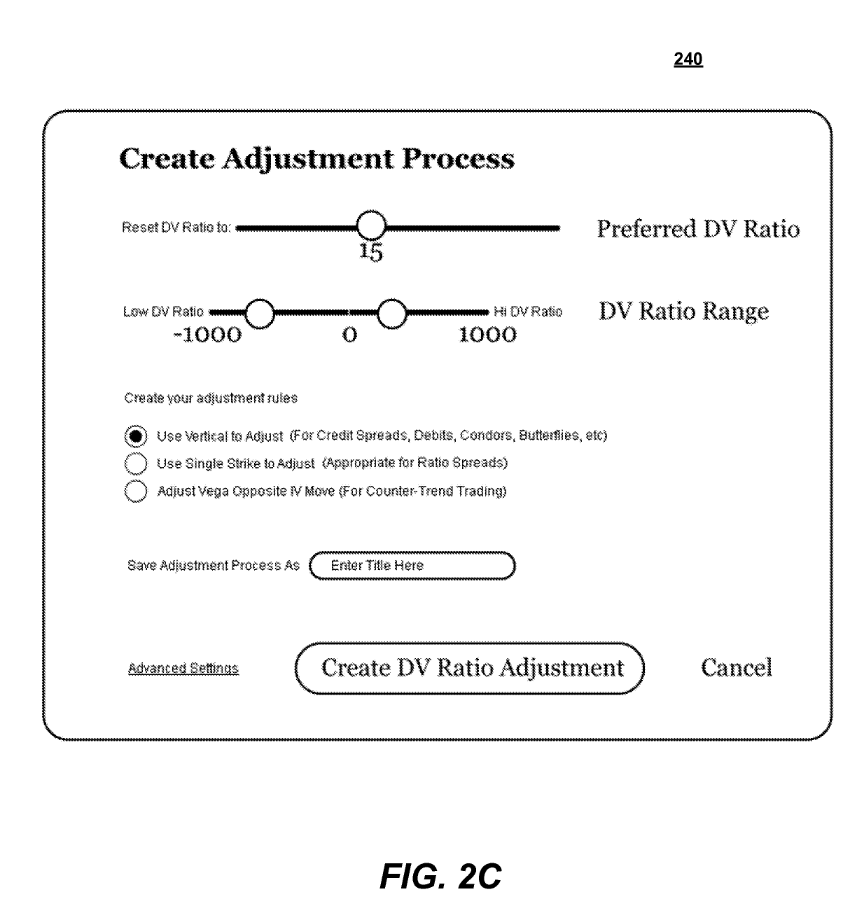

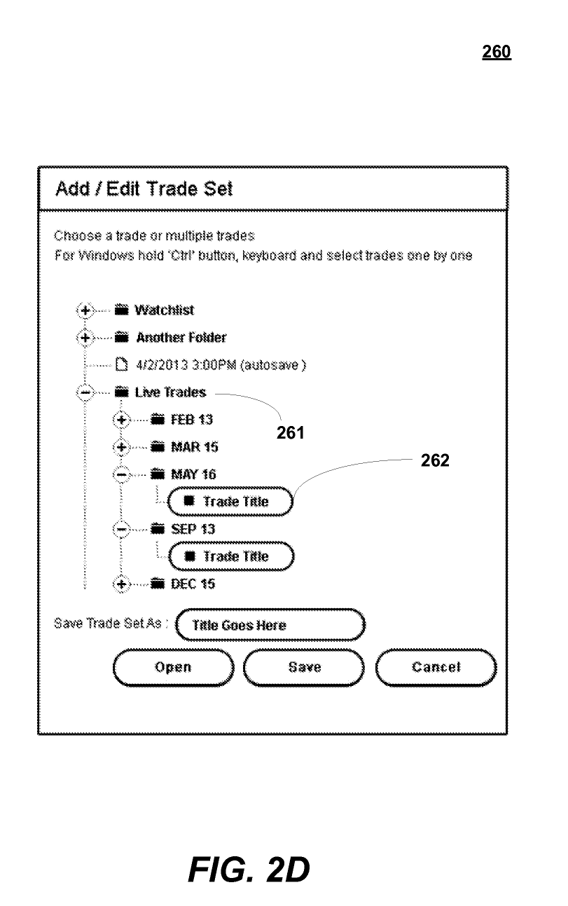

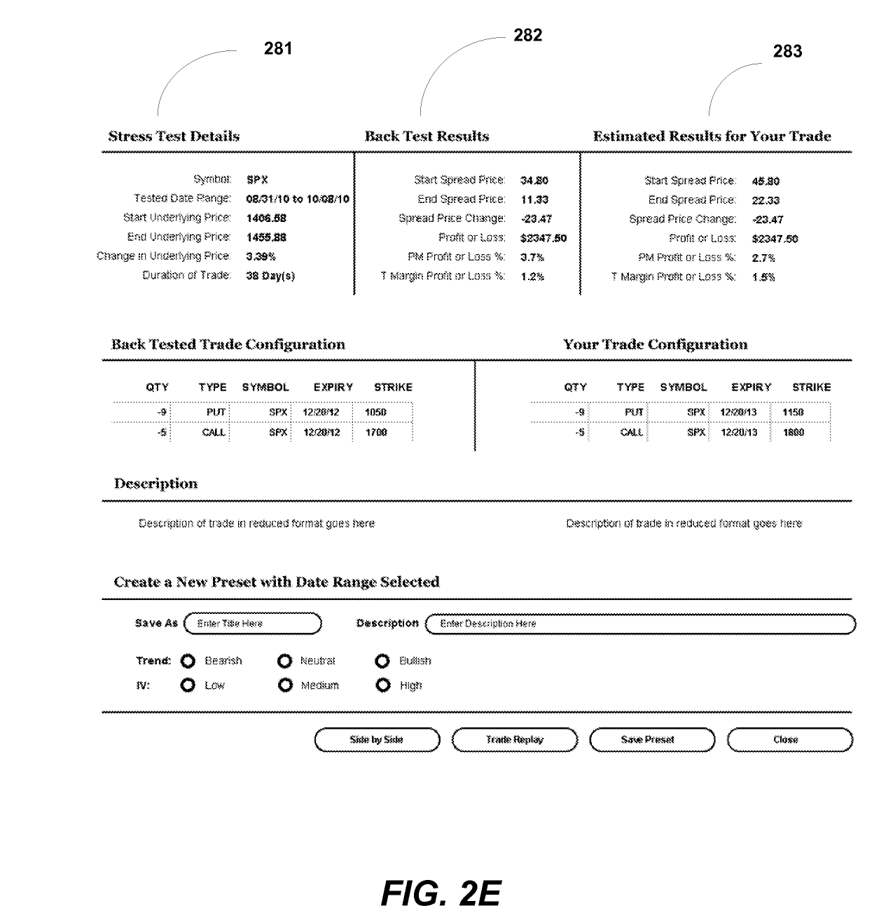

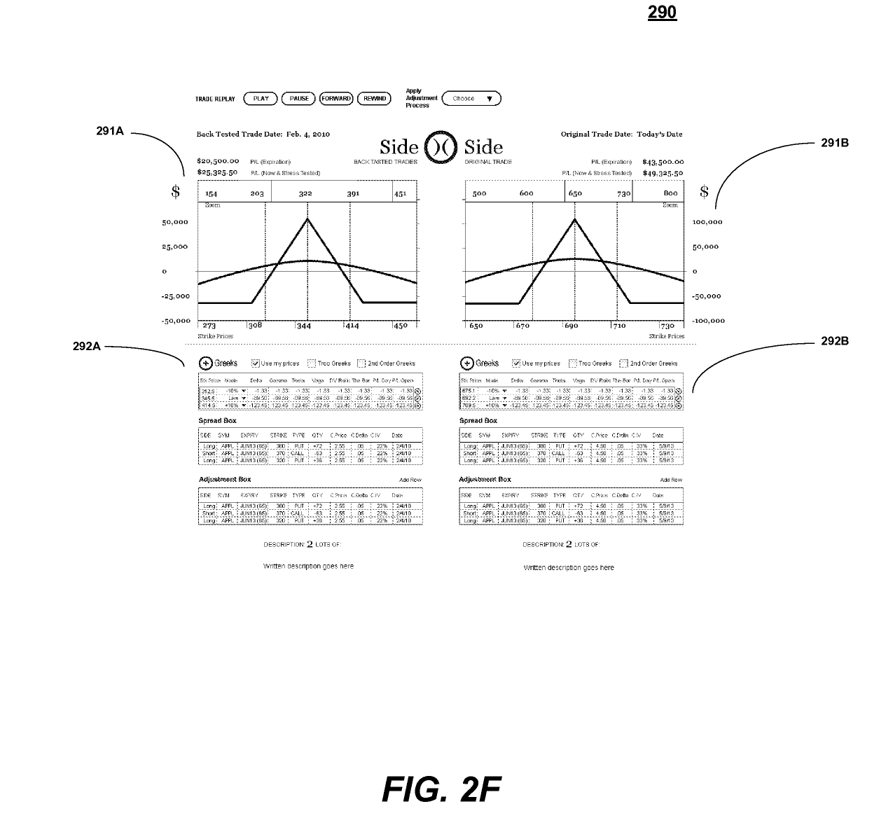

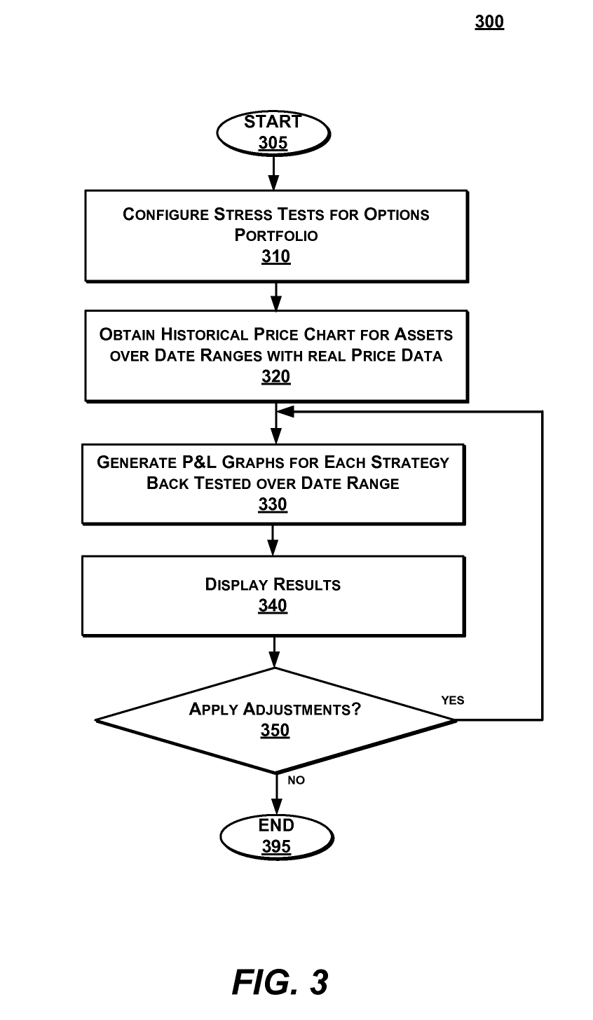

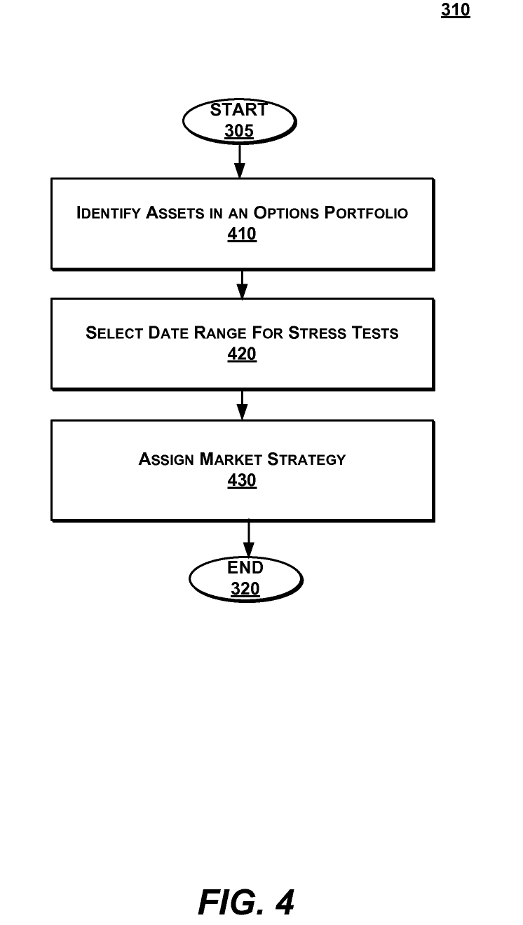

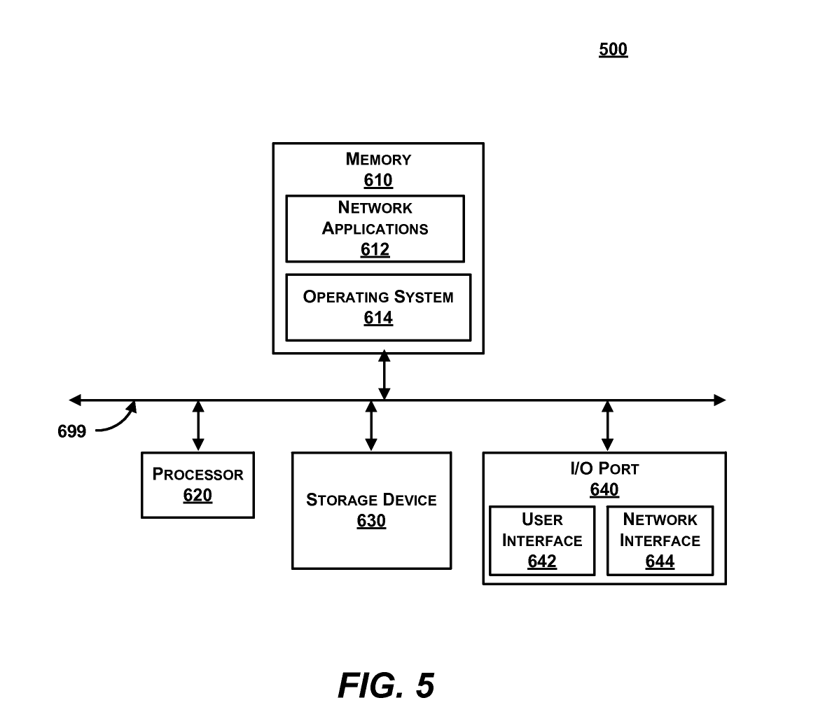

### DESCRIPTION

Spread: A spread or option spread, involves opening a pair of complimentary or contrasting option trades with different strike prices. Usually, it is a combination of selling and buying an option at different strike prices.

Optionable: Financial instruments that allow users to purchase or sell options on a market exchange. They can be stocks, futures, currencies, indices, etc.

The disclosed technique will show the option trader many things and very quickly.

1. How the portfolio may perform in a bearish market based on real data.
2. How the portfolio may perform in a neutral market based on real data.
3. How the portfolio may perform in a bullish market based on real data.
4. How the portfolio will perform with various moves in Implied Volatility using real IV moves.
5. How the portfolio will behave with various durations of time. (Day, week, month, etc) using real data.
6. How well the portfolio is balanced. The user will quickly be able to see if the hedge he/she is using is balanced properly to protect the portfolio.
7. How to size the trades. Troo™ Risk will show the user if he/she is over extending his/her margin by displaying all the back tested results to the user.

By using real data human behavior, liquidity and bid-ask spread information is factored into the equation. Humans tend to react in similar ways over and over again, and my studies have shown that I can factor this information into my calculations. With a couple clicks of the mouse the Troo™ Risk module can do dozens of back tests in customizable presets for the user and present the results in a usable interface. Then the user can make adjustments to the portfolio and retest all scenarios once again with a click of the mouse. What my invention can do in seconds would take days to do with current designs. The ease of use and time saved will help the option trader to be safer and more profitable. A lot of the guess work will be removed. I forgot to mention, but with traditional models, the user not only relies on theoretical data, but the user also has to guess how much to change IV and time. There is so much guess-work involved that the user's trading results are far off from what they analyze and anticipate.

In addition to providing a user a way to instantly back test a live portfolio in seconds, I have also formulated a new pricing model that uses real data as the foundation. All the user needs to do with my model is change the time and price, and the software will change the IV automatically based on my calculations gathered from real, historical data. The produces an option price which factors in reality instead of theoretical data only.

Troo™ Risk also has the capability to customize presets based on the Troo™ Risk Pricing Model (mentioned above). Therefore, a user can also do dozens of predetermined back tests with the model.

The user can also use the Black Scholes model and create presets as well. This will allow the user to compare theoretical data to real data and make better trading decisions. Currently, traders can already use the Black Scholes, but I haven't seen any software that will allow a user to create and save presets in order to stress test faster and compare data in this manner. This method also saves the user time and energy and will allow the user to utilize the Black Scholes model more efficiently and more accurately as well. By providing a user a way to save preset Black Scholes stress tests, each test can be optimized and more accurately based on real historical events. This will improve the user's accuracy and implementation of using the Black Scholes model to stress test.

I claim:

1. A computer-implemented method for back-testing strategies over customizable preset date ranges in an options portfolio, the method comprising:
configuring a set of stress tests, comprising:
identifying a plurality of assets in an options portfolio, and an option chain for each asset from a user,
selecting a date range received from the user for each of the set of stress tests, and
assigning a market strategy received from the user for each of the stress tests;
obtaining historical price charts for the plurality of assets in the options portfolio, each historical price chart comprising real price data in accordance with the date range;
generating P&L (profit and loss) graphs including a P&L graph for each stress test showing an amount of profit or loss over the date range configured by applying the option chain to the historical price chart; and
outputting a display of the P&L graph corresponding to each of the stress tests for the options portfolio.

2. The method of claim 1:
wherein receiving a market strategy comprises receiving a market volatility rating,
and wherein displaying the P&L graphs comprises displaying the P&L graphs organized by the market volatility rating.

3. The method of claim 1, wherein:
receiving a market strategy comprises receiving a market performance setting of at least one of bearish, neutral or bearish,
and wherein displaying the P&L graphs comprises displaying the P&L graphs for each of the one or more market performance settings.

4. The method of claim 1, further comprising:
displaying the P&L graphs comprises displaying a set of superimposed curves for each P&L graph, each curve representing a performance for one or the assets over the date range.

5. The method of claim 1, wherein:
displaying the P&L graphs comprises displaying one or more P&L graphs organized according to market strategy.

6. The method of claim 1, further comprising
providing a side-by-side analysis for each stress test to compare Greek characteristics of a stress test to real data.

7. The method of claim 1, wherein the option chain for each asset comprises either a real option trade or a hypothetical option trade.

8. The method of claim 1, further comprising:
assigning a name to each of the set of stress tests as indicated by the user.

9. A non-transitory computer-readable medium storing instructions that, when executed by a processor, perform a computer-implemented method for back-testing strategies over customizable preset date ranges in an options portfolio, the method comprising:
configuring a set of stress tests, comprising:
identifying a plurality of assets in an options portfolio, and an option chain for each asset from a user,
selecting a date range received from the user for each of the set of stress tests, and
assigning a market strategy received from the user for each of the stress tests;
obtaining historical price charts for the plurality of assets in the options portfolio, each historical price chart comprising real price data in accordance with the date range;
generating P&L (profit and loss) graphs including a P&L graph for each stress test showing an amount of profit or loss over the date range configured by applying the option chain to the historical price chart; and
outputting a display of the P&L graph corresponding to each of the stress tests for the options portfolio.

10. A back-test server on a data network to back-test strategies over customizable preset date ranges in an options portfolio, the method comprising, comprising:
a user interface to receive configurations for a set of stress tests, wherein the configurations comprise an identification of a plurality of assets in an options portfolio and an option chain for each asset from a user, a selection of a date range received from the user for each of the set of stress tests, and an assignment of a market strategy received from the user for each of the stress tests;
an asset performance processor to obtain historical price charts for the plurality of assets in the options portfolio, each historical price chart comprising real price data in accordance with the date range, the asset performance processor to generate a P&L (profit and loss) graphs including a P&L graph for each stress test showing an amount of profit or loss over the date range configured by applying the option chain to the historical price chart; and
a P&L graph module to output a display of the P&L graph corresponding to each of the stress tests for the options portfolio.
